(19) United States
(12) Patent Application Publication
(10) Pub. No.: US 2013/0105709 A1
(43) Pub. Date: May 2, 2013

(54) Optical Cavity Mode Excitations in Magnetic Fluorescent Microparticles

(71) Applicant: Michael Himmelhaus, Berlin (DE)

(72) Inventor: Michael Himmelhaus, Berlin (DE)

(21) Appl. No.: 13/701,209

(22) PCT Filed: May 30, 2011
(86) PCT No.: PCT/JP2011/062859

§ 371 Date: Dec. 19, 2012

Related U.S. Application Data
(60) Provisional application No. 61/351,432, filed on Jun. 4, 2010.

(51) Int. Cl. G01N 21/64

(52) U.S. Cl. CPC G01N 21/64
USPC 250/459.1; 250/458.1; 250/200

(57) ABSTRACT

An optical cavity mode apparatus comprises at least one microcavity having magnetism; a light source for supplying light irradiation to the microcavity; an optical apparatus for detection of optical cavity modes of the microcavity; and a magnetic controller for magnetically controlling the position of the microcavity.

### TECHNICAL FIELD

The present invention relates to a technology related to an optical sensor based on optical cavity mode excitations in magnetic optical microcavities.

U.S. provisional patent application No. 60/796,162 filed on May 1, 2006, PCT application No. PCT/JP2007/059,443 filed on Apr. 26, 2007, U.S. provisional patent application No. 61/018,144 filed on Dec. 31, 2007, U.S. patent application Ser. No. 11/918,944 filed on May 15, 2007, U.S. provisional patent application No. 61/111,369 filed on Nov. 7, 2008, and U.S. provisional patent application No. 61/140,790 filed on Dec. 24, 2008 are incorporated by reference herein for all purposes.

### BACKGROUND ART

Optical microcavities have been successfully applied to a variety of applications in optics, such as miniature laser sources (J. L. Jewell et al., Appl. Phys. Lett. Vol. 54, pp. 1400ff., 1989; M. Kuwata-Gonokami et al., Jpn. J. Appl. Phys. (Part 2) Vol. 31, pp. L99ff., 1992; S. M. Spillane et al., Nature (London) Vol. 415, pp. 621ff., 2002; V. N. Astratov et al., Appl. Phys. Lett. Vol. 85, pp. 5508ff., 2004), optical waveguides (V. N. Astratov et al., Appl. Phys. Lett. Vol. 85, pp. 5508ff., 2004), optical filters (L. Maleki et al., Proc. SPIE Vol. 5435, pp. 178ff., 2004), and mechanical (M. Gerlach et al., Opt. Express Vol. 15, pp. 3597ff., 2007) or biological sensors (V. S. Ilchenko and L. Maleki, Proc. SPIE Vol. 4270, pp. 120ff., 2001; F. Vollmer et al., Appl. Phys. Lett. Vol. 80, pp. 4057ff., 2002). A number of recent reviews discuss fundamentals and the various applications of these systems in more detail (A. B. Matsko and V. S. Ilchenko, IEEE J. Sel. Top. Quantum Electron. Vol. 12, pp. 3ff., 2006; V. S. Ilchenko and A. B. Matsko, IEEE J. Sel. Top. Quantum Electron. Vol. 12, pp. 15ff., 2006; K. Vahala, Nature Vol. 424, pp. 839-846, 2003; A. N. Oraevsky, Quant. Electron. Vol. 32, pp. 377-400, 2002; F. Vollmer, S. Arnold, Nature Methods Vol. 5, pp. 591-596, 2008).

Thereby, different embodiments for optical microcavity operation have been utilized. In the following, a summary of the different schemes is given.

a) Work utilizing non-metallic microcavities with few micrometers of geometric cavity length: WO2005116615 describes the utilization of whispering gallery modes (WGMs) in spherical particles decorated with fluorescent semiconductor quantum dots for biosensing. Weller et al. (A. Weller et al., Appl. Phys. B Vol. 90, pp. 561-567, 2008) report on biosensing by means of fluorescent polymer latex particles of few microns in diameter.

Francois and Himmelhaus (A. Francois and M. Himmelhaus, Appl. Phys. Lett. Vol. 92, pp. 141107/1-3, 2008) utilized clusters of dye-doped polymer latex particles for biosensing. Woggon and coworkers (N. Le Thomas et al., J. Opt. Soc. Am. B Vol. 23, pp. 2361-2365, 2006) demonstrated that the mode spectrum of non-fluorescent polymer latex particles can be exited in a range of some tens of nanometers by using a sharply focused broadband light source, such as a tungsten lamp or the output of an optical parametric oscillator, in combination with evanescent field coupling.

b) Work utilizing dielectric microcavities of several tens to several hundreds of micrometers of geometric cavity length: US2002/0097401A1, WO 02/13337A1, WO 02/01147A1, US 2003/0206693A1, US2005/022153A1, and WO 2004/038349A1.

Besides the non-metallic microcavities as used in the systems described above, also metal-coated or metal-decorated cavities can be utilized. WO 02/07113A1, WO 01/15288 A1, US 2004/0150818A1, and US 2003/0218744A1 describe the use of metal particles, metal particle aggregates, and semi-continuous metal films close to their percolation threshold, which may be optionally located in vicinity of a hollow microcavity, i.e. which may be optionally embedded inside of the microcavity. The metal particles/films may further bear a fluorescent material, such as a laser dye. WO2007129682 describes the use of fluorescent dielectric microcavities encapsulated into a metallic coating for biosensing applications.

Magnetic particles and composites thereof for applications in catalysis, environmental remediation, microfluidics, cell separation, immunomagnetic separation and related applications in the biomedical field and (bio-) sensing have been developed in recent years in numerous types in nanometer to micrometer dimensions and with a variety of surface functionalizations (L. Stanciu et al., Sensors Vol. 9, pp. 2976-2999, 2009; C. Liu et al., J. Appl. Phys. Vol. 105, pp. 102014/1-11, 2009; N. Jaffreciz-Renault, Sensors Vol. 7, pp. 589-614, 2007; N. Pamme, Lab Chip Vol. 6, pp. 24-38, 2006). In most cases, the particles are hybrid particles consisting of nano-sized magnetic particles embedded into a polymeric or inorganic matrix material with an aim to improve stability of the colloidal suspension in view of particle aggregation and sedimentation and to provide opportunity for (bio-) chemical surface functionalization.

Recently, also fluorescent magnetic particles have been fabricated, for example by embedding a fluorescent dye into the polymer matrix of a hybrid particle, and even have become commercially available (e.g., Compel magnetic fluorescent microspheres, Bangs Laboratories, Inc., Fisher, Ind.).

### SUMMARY OF INVENTION

### Technical Problem

The present invention has been achieved in order to solve problems in the above mentioned arts.

### Solution to Problem

According to one aspect of the present invention, an optical cavity mode apparatus comprises at least one microcavity having magnetism; a light source for supplying light irradiation to the microcavity; an optical apparatus for detection of optical cavity modes of the microcavity; and a magnetic controller for magnetically controlling position of the microcavity.

According to another aspect of the present invention, a method for sensing a target object using optical mode excitations in at least one microcavity, comprises the steps of: preparing the microcavity having magnetism; exciting the microcavity by irradiation of a light source to obtain spectra of the microcavity; detecting at least one optical cavity mode of the microcavity stimulated by the light source, wherein the position of the microcavity is controlled by a magnetic controller.

According to another aspect of the present invention, a method for sensing a target object using optical mode excitations in at least one microcavity, comprising the steps of: preparing the microcavity having magnetism; exciting the microcavity by irradiation of a light source to obtain spectra of the microcavity; detecting at least one optical cavity modes of the microcavity stimulated by the light source, wherein the microcavity interacts with magnetized material.

### BRIEF DESCRIPTION OF DRAWINGS

FIG. 1 shows a microcavity or a cluster as an aggregate of microcavities optionally containing a fluorescent material for excitation of optical cavity modes in the microcavity or cluster of microcavities: (a) a single microcavity without a coating; (b) a single microcavity with a coating for achievement of wanted optical properties; (c) a cluster as an aggregate of microcavities without a coating; a cluster as an aggregate of microcavities which are coated in either such a way that (d) each cavity is individually coated or (e) in such a way that neighboring cavities form optical contacts with each other.

FIG. 2 shows two basic schemes of hybrid particles containing a magnetizable material, wherein in scheme (I) the magnetizable material 2 is distributed over the core 1 of the hybrid particle and in scheme (II) the magnetizable material 2 is a coating of the core 1; the outer coating 3 is optional.

FIG. 3 compares the normalized optical transmission 1 of an aqueous suspension of 8 μm polystyrene beads containing magnetite with the excitation laser position 2 and the fluorescence emission 3 of Nile Red as chosen for Examples 2 and 3.

FIG. 4 shows an experimental set-up for preparation of fluorescent paramagnetic beads.

FIG. 5 shows fluorescence emission spectra of Bangs Compel magnetic microbeads with a nominal diameter of 8 μm either doped with Nile Red (a) or non-doped, i.e. not containing any fluorescent dye, (b).

### DESCRIPTION OF EMBODIMENTS

Exemplary embodiments relating to the present invention will be explained in detail below with reference to the accompanying drawings.

### (i) Definition of Terms

CCD: Charge-coupled device
FPM: Fabry-Perot mode
LED: Light emitting diode
NR: Nile Red
PBS: Phosphate buffered saline
PS: Poly(styrene)
QD: (semiconductor) quantum dot
Q-Factor: Quality factor
TIR: Total internal reflection
TE: Transverse electric (optical mode)
TM: Transverse magnetic (optical mode)
WGM: Whispering gallery mode

Reflection and Transmission at a Surface:

In general, the surface of a material has the ability to reflect a fraction of impinging light back into its ambient, while another fraction is transmitted into the material, where it may be absorbed in the course of its travel. In the following we call the power ratio of reflected light to incident light the “Reflectivity” or “Reflectance”, R, of the ambient/material interface (or material/ambient interface). Accordingly, the power ratio of transmitted light to incident light is called the “Transmittance”, T, of this interface. Note, that R and T both are properties of the interface, i.e. their values depend on the optical properties of both, the material and its ambient. Further, they depend on the angle of incidence and the polarization of the light impinging onto this interface. Both R and T can be calculated by means of the Fresnel equations for reflection and transmission. The same terminology can be also applied to the total reflection and total transmission of a stratified sequence of interfaces.

Optical Cavity:

An optical cavity is a closed volume confined by a closed boundary area (the “surface” of the cavity), which is highly reflective to light in the ultraviolet (UV), visible (vis) and/or infrared (IR) region of the electromagnetic spectrum. Besides its wavelength dependence, the reflectance of this boundary area may also be dependent on the incidence angle of the light impinging on the boundary area with respect to the local surface normal. Further, the reflectance may depend on the location, i.e. where the light impinges onto the boundary area. The inner volume of the optical cavity may consist of vacuum, air, or any material that shows high transmission in the UV, visible, and/or IR. In particular, transmission should be high at least for a part of those regions of the electromagnetic spectrum, for which the surface of the cavity shows high reflectance. An optical cavity may be coated with a material different from the material of which the optical cavity is made. The material used for coating may have, e.g., different optical properties, such as different refractive index or absorption coefficient. Further it may comprise different physical, chemical, or biochemical properties than the material of the optical cavity, such as different mechanical strength, chemical inertness or reactivity, and/or antifouling or related biofunctional functionality. In the following, this optional coating is referred to as “shell”, while the optical cavity is called “core”. The total system, i.e. core and shell together, are referred to as “(optical) microresonator”. The latter term is also used to describe the total system in the case that no shell material is applied. In addition to the shell discussed here, a part of the surface of the microresonator may be coated with additional layers (e.g. on top of the shell) as a part of the sensing process, for example to provide a suitable biofunctional interface for detection of specific binding events or in the course of the sensing process when target molecules adsorb on the microresonator surface or a part of it.

An optical cavity (microresonator) is characterized by two parameters:

First, its volume V, and second, its quality factor Q. Alternatively, an optical cavity (microresonator) may be characterized in terms of the free spectral range(s) δλₘ and the bandwidth(s) Δλₘ of its optical cavity modes (for definitions see below). In the following, the term “optical cavity” (“microresonator”) refers to those optical cavities (microresonators) with a quality factor Q>1. Depending on the shell material used, the light stored in the microresonator may be stored in the optical cavity solely, e.g. when using a highly reflective metal shell, or it may also penetrate into the shell, e.g. when using a dielectric or semiconducting shell. Therefore, it depends on the particular system under consideration, which terms (volume and Q-factor of the optical cavity or those of the microresonator) are more suitable to characterize the resulting optical properties of the microresonator.

Quality Factor:

The quality factor (or “Q-factor”) of an optical cavity is a measure of its potential to trap photons inside of the cavity. It is defined as

$$\begin{matrix}[ Math . 1 ] & \\ Q = \frac{stored energy}{loss per roundtrip} = \frac{{ω}_{m}}{Δ {ω}_{m}} = \frac{{λ}_{m}}{Δ {λ}_{m}} & ( 1 )\end{matrix}$$

where ωₘ and λₘ are the frequency and (vacuum) wavelength of the cavity mode with mode number m, respectively, and Δωₘ and Δλₘ are the corresponding bandwidths. The latter two equations connect the Q-factor with the position and bandwidth of the optical modes inside of the cavity. Obviously, the storage potential of a cavity depends on the reflectance of its surface. Accordingly, the Q-factor may be dependent on the characteristics of the cavity modes, such as their wavelength, polarization, and direction of propagation, and thus may be different for different modes.

Volume of an Optical Cavity:

The volume of an optical cavity is defined as its inner geometrical volume, which is confined by the surface of the cavity, i.e. the reflective boundary area.

Free Spectral Range (FSR):

The free spectral range (FSR) δλ of an optical system refers to the spacing between its optical modes. For an optical cavity, the FSR is defined as the mode spacing, δλₘ=λₘ−λₘ+1, where m is the mode number and λₘ>λₘ₊₁.

Ambient (Environment) of an Optical Cavity or Microresonator:

The “ambient” or “environment” of an optical cavity or microresonator is that volume enclosing the cavity (microresonator), which is neither part of the optical cavity, nor of its optional shell (in the case of a microresonator). In particular, the highly reflective surface of the optical cavity (or microresonator) is not part of its ambient. It must be noted that in practice, the highly reflective surface of the optical cavity (microresonator) has a finite thickness, which is not part of the ambient. The same holds for the optional shell, which has also a finite thickness and does not belong to the microresonator's ambient. The ambient or environment of an optical cavity (microresonator) may comprise entirely different physical and chemical properties from that of the cavity (microresonator), in particular different optical, mechanical, electrical, and (bio-)chemical properties. For example, it may strongly absorb in the electromagnetic region, in which the optical cavity (microresonator) is operated. The ambient may be heterogeneous. The extension to which the enclosing volume is considered as ambient, depends on the application. In the case of a microresonator brought into a microfluidic device, it may be the microfluidic channel. Typically, the ambient it is that part of the enclosing volume of the optical cavity or microresonator, which is of relevance for the optical cavity's (microresonator's) operation, for example in terms of its impact on the optical cavity modes of the cavity (microresonator) in view of their properties, excitation, and/or detection.

Optical Cavity Mode:

An optical cavity mode or just “cavity mode” is a wave solution of the electromagnetic field equations (Maxwell equations) for a given cavity. Different modes may have different directions of propagation depending on geometry and optical properties of the cavity. These modes are discrete and can be numbered with an integer m, the so-called “mode number”, due to the restrictive boundary conditions at the cavity surface. Accordingly, the electromagnetic spectrum in the presence of the cavity can be divided into allowed and forbidden zones. The complete solution of the Maxwell equations consists of internal and external electromagnetic fields inside and outside of the cavity, respectively. In the following, the term “cavity mode” refers to the inner electromagnetic fields inside the cavity (within the cavity volume as defined above) unless otherwise stated. The wave solutions depend on the shape and volume of the cavity as well as on the reflectance of the boundary area, i.e. the cavity surface.

The full set of solutions of Maxwell's equations comprises also the fields outside of the optical cavity (microresonator), i.e. in the cavity's (microresonator's) ambient. Here, two kinds of solutions must be distinguished: those where the solutions describe freely propagating waves in the ambient and those where the solutions describe evanescent fields. The latter come into existence for waves, for which propagation in the ambient is forbidden, e.g. due to total internal reflection at the surface of the optical cavity (microresonator). One example for optical cavity modes that comprise evanescent fields in the ambient are WGMs. Another example is related to microresonators with a metal coating as shell. In these cases, surface plasmons may be excited at the metal/ambient interface, which also may exhibit an evanescent field extending into the ambient. In all these cases the evanescent field extents typically for a distance roughly of the order of the wavelength of the light generating the evanescent field into the ambient.

It should be noted that in practice, also evanescent fields may show some leakage, i.e. propagation of photons out of the evanescent field into the far field of the optical cavity, i.e. far beyond the extension of the evanescent field into the ambient. Such waves are caused, for example, by scattering of photons at imperfections or other kinds of causes, which are typically not accounted for in the theoretical description, since the latter typically assumes smooth interfaces and boundary layers. Such stray light effects are not considered in the following, i.e. do not hamper the evanescent field character of an ideally evanescent field. In the same way, evanescent field tunneling across a nanometer-sized gap into a medium, in which wave propagation is then allowed, does not hamper the evanescent field character of the evanescent field.

For spherical cavities, there exist two main types of solutions, for which the wavelength dependence can be easily estimated, one for light propagation in radial direction and one for light propagation along the circumference of the sphere, respectively. In the following, we will call the modes in radial direction “Fabry-Perot Modes” (FPM) due to analogy with Fabry-Perot interferometers. The modes forming along the circumference of the spheres are called “Whispering Gallery Modes” (WGM) in analogy to an acoustic phenomenon discovered by Lord Rayleigh. For a simple mathematical description of the wavelength dependence of these modes, we use the standing wave boundary conditions in the following:

$$\begin{matrix}[ Math . 2 ] & \\ {λ}_{m} = \frac{4 R {n}_{cav}}{m} , m = 1 , 2 , 3 , … & ( 2 )\end{matrix}$$

for FPM, which states that the electric field at the inner cavity surface as to vanish for all times, as is the case e.g. for a cavity with a metallic coating. For WGM, the boundary conditions yield

$$\begin{matrix}[ Math . 3 ] & \\ {λ}_{m} = \frac{2 π R {n}_{cav}}{m} , & ( 3 )\end{matrix}$$

which basically states that the wave has to return in phase after a full roundtrip. In both formulas, “m” is an integer and is also used for numbering of the modes, i.e., as their mode number, R is the sphere radius, and n_{cav} is the refractive index inside of the cavity. For the sake of brevity, in the following the term “cavity mode m” will be used synonymously with the term “cavity mode with mode number m”. From equations (2) and (3), the FSR δλₘ of FPMs and WGMs, respectively, of spherical cavities can be calculated to

$$\begin{matrix}[ Math . 4 ] & \\ δ {λ}_{m} = \frac{{λ}_{m}}{m + 1} = \frac{{λ}_{m + 1}}{m} & ( 4 )\end{matrix}$$

Dimension of an Optical Cavity or Microresonator:

The “dimension” or “size” of an optical cavity or microresonator is a measure for is spatial extension. For a spherical optical cavity or microresonator, it is its diameter, for an ellipsoidal optical cavity or microresonator, it is the length of its largest principal axis. For an optical cavity or microresonator of arbitrary shape, the dimension (size) is given by the diameter of the smallest sphere that can fully engulf the optical cavity or microresonator.

Optical Microcavity:

In the following, an optical cavity or microresonator will be called “optical microcavity”, if it has a dimension of below one millimeter. Accordingly, a cluster of optical cavities or microresonators will be called a “cluster of optical microcavities”, if the dimension of at least one of the constituting optical cavities or microresonators is below one millimeter.

Further, one or more microcavities or clusters of microcavities may be part of a more complex optical system comprising also other kinds of optical elements than microcavities or clusters of microcavities as defined above. Also such more complex systems will be called “microcavity” or “cluster of microcavities” in the following, depending on which of the two systems they preferentially contain.

Magnetic Optical Microcavity:

An optical microcavity or cluster of optical microcavities is called “magnetic” if the optical microcavity or at least on of the optical cavities or microresonators constituting the cluster of optical microcavities can interact with magnetic materials via magnetic forces.

Mode Coupling:

We define mode coupling as the interaction between cavity modes emitted by two or more microresonators that are positioned in contact with each other or in close vicinity to allow an optical contact. This phenomenon has been pointed out by S. Deng et al. (Opt. Express Vol. 12, pp. 6468-6480, 2004), who have performed simulations on mode guiding through a series of microspheres. The same phenomenon has been is experimentally demonstrated by V. N. Astratov et al. (Appl. Phys. Lett. Vol. 83, pp. 5508-5510, 2004), who used a chain of non-fluorescent microspheres as a waveguide and a single fluorescent microsphere positioned at one end of the microsphere waveguide in order to couple light into the chain. They have shown that the cavity modes produced by the fluorescent microsphere under excitation can propagate along the non-fluorescent microsphere chain, which means that light can be coupled from one sphere to another. The authors relate this coupling from one microsphere to another to “the formation of strongly coupled molecular modes or crystal band structures”.

T. Mukaiyama et al. (Phys. Rev. Lett. Vol. 82, pp. 4623-4626, 1999) have studied cavity mode coupling between two microspheres as a function of the radius mismatch between the microspheres. They have found that the resulting cavity mode spectrum of the bi-sphere system is highly depending on the radius mismatch of the two microspheres. More recently, P. Shashanka et al. (Opt. Express Vol. 14, pp. 9460-9466, 2006) have shown that optical coupling of cavity modes generated in two microspheres can occur despite of a large radius mismatch (8 and 5 μm). They have shown that the coupling efficiency depends strongly on the spacing between the two microspheres and as a result, the positions of the resonant wavelengths also depend on the microsphere spacing.

Optical Contact:

Two microresonators are said to have an “optical contact”, if light can transmit from one resonator to the other one and vice versa. In this sense, an optical contact allows potentially for mode coupling between two resonators in the sense defined above. Accordingly, a microresonator has an optical contact with the substrate if it may exchange light with it.

Clusters:

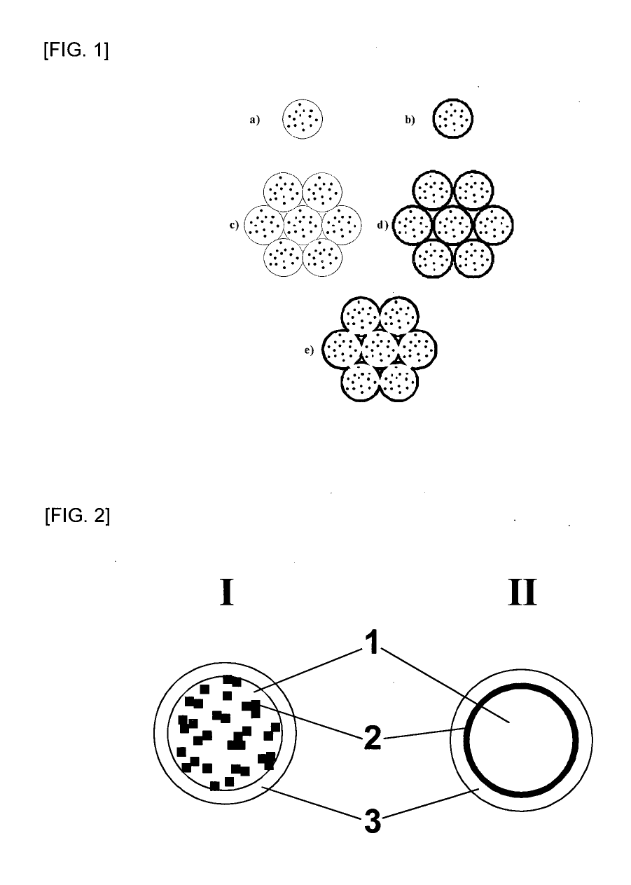

A cluster is defined as an aggregate of cavities (microresonators) which may be either in 2 or 3 dimensions (cf. FIG. 1(c)-(e)). The individual cavities (microresonators) are either positioned in such way that they are in contact with each other or in close vicinity in order to promote the superposition of their cavity mode spectra and/or cavity mode coupling. They may be attached to a surface or float freely in a liquid medium. Further, they may be—at least temporally—detached from a surface. The individual cavities may be coated as described above in either such a way that each cavity is individually coated (FIG. 1(d)) or in such a way that neighboring cavities within a cluster form optical contacts with each other (FIG. 1(e)). The cluster may be formed randomly or in an ordered fashion for example using micromanipulation techniques, micropatterning and/or self-assembly. Further, the cluster may be formed in the course of a sensing process, for example inside of a medium, such as a live cell, after penetration of cavities (microresonators) into the medium to facilitate sensing of the wanted physical, chemical, biochemical, and/or biomechanical property. Also, combinations of all schemes shown in FIG. 1 are feasible. In general, the clusters of particles can be distributed over the surface in a random or an ordered fashion, which may be either in two- or in three-dimensional structures. Thereby, photonic crystals may be formed.

Lasing Threshold:

The threshold for stimulated emission of a microresonator (optical cavity), also called the “lasing threshold”, is defined as the optical pump power of the microresonator where the light amplification via stimulated emission just compensates the losses occurring during propagation of the corresponding light ray within the microresonator. Since the losses for light rays traveling within a cavity mode are lower than for light rays that do not match a cavity mode, the cavity modes exhibit typically the lowest lasing thresholds (which may still differ from each other depending on the actual losses of the respective modes) of all potential optical excitations of a microresonator. In practice, the lasing threshold can be determined by monitoring the optical output power of the microresonator (e.g. for a specific optical cavity mode) as a function of the optical pump power used to stimulate the fluorescent material of the microcavity (also called the “active medium” in laser physics). Typically, the slope of this dependence is (significantly) higher above than below the lasing threshold so that the lasing threshold can be determined from the intersection of these two dependencies (cf. for example A. Francois, M. Himmelhaus, Appl. Phys. Lett. Vol. 94, 031101, 2009). When talking about the “lasing threshold of an optical microresonator”, one typically refers to the lasing threshold of that optical cavity mode with the lowest threshold within the observed (utilized) spectral range. A similar definition holds accordingly for a cluster of microresonators. Here, the “lasing threshold of a cluster of optical microresonators” may be envisioned as the lasing threshold of that optical cavity mode generated in the cluster (by any of its constituting microresonators and/or any combination(s) thereof) with the lowest threshold within the observed (utilized) spectral range.

Optical microresonators and clusters of the microresonators have been shown to be promising tools for the development of optical sensors of small dimension with the dependency of their cavity mode excitations on external parameters, which influence their immediate environment, as the transducer mechanism.

One major advantage of the application of small sensors, e.g. in the sub-millimeter regime, would be to allow highly localized sensing of the physical and/or (bio-) chemical condition of the target. For example, in a microfluidic flow system, physical and/or (bio-) chemical quantities of interest, such as refractive index, temperature, pressure, flow velocity, turbidity, and analyte concentration, could be measured at different positions within the system either simultaneously by a plurality of sensors or in serial fashion, point by point, using a scanning sensor, thereby yielding detailed insight into the flow system's characteristics. Such information would be very valuable in view of the further optimization of such systems with regard to the speed and accuracy of their performance and the total yield, e.g., in the case of a microfluidic synthesis process.

Another example of the benefits of small sensors is related to in-vitro or even in-vivo applications. Recently, it has been shown that optical cavity mode sensors can be incorporated by live cells and be used for the measurement of biomechanical forces during endocytosis (U.S. provisional patent application No. 61/111,369 filed on Nov. 7, 2008; A. Francois and M. Himmelhaus, Biosens. Bioelectron. Vol. 25, pp. 418-427, 2009). This became merely possible because the total sensor size was reduced to a dimension below the size limit for phagocytosis of the cell line used.

These examples have in common that besides the requirements of a small sensor that allows for spatially highly resolved measurements, also a position control function is wanted. This means that it would be advantageous if such small sensor(s) could be controlled externally, for example by electrical, magnetic, and/or electromagnetic forces, to allow its (their) precise positioning, e.g., to scan the inner volume of a microfluidic device or that of a live cell. Other applications benefiting of an at least temporal position control may be related to sensing processes that require several treatment steps, for example, for analyte exposure and/or rinsing. In such cases it may be wanted to move the sensor(s) to a wanted position during the treatment(s) and to define different positions for different treatments, e.g., for optimization of the sensor(s') performance.

Techniques based on electrical, magnetic, and electromagnetic forces have been reported for such means, for example via electrophoresis (S. P. Radko and A. Chrambach, Electrophoresis Vol. 23, pp. 1957-1972, 2002) and magnetic (M. Tanase et al., Cell Mechanics Vol. 83, pp. 473-493, 2007) or optical (K. O. Greulich et al., J. Microscopy Vol. 198, pp. 182-187, 2000) tweezers. Among these methods, magnetic tweezers, i.e. the application of magnetic forces to a magnetizable particle, have the advantage that the forces can be relatively strong, thus allowing fast movement of and good control on the particle, and that they typically do not interfere with the particle's dielectric environment. This is very important in particular for sensing, where any influence of the sensing apparatus on the result of the measurement is unwanted.

For these reasons, the development of magnetizable microscopic optical sensors based on optical cavity mode excitations seems to be a considerable target. One problem in the implementation of such sensors is, however, that the substances typically utilized to render a particle magnetizable, exhibit optical properties that may hamper optical cavity mode excitations due to increased light absorption and scattering. Both cause a decrease of the quality factor, which is a measure for the photons' storage time inside the cavity, and thus, according to eq. 1, lead to increased bandwidths of the excited optical cavity modes. The latter is unwanted because it may affect the detection limit of the sensor or even may render the modes unobservable, e.g., in the case Δλ>δλ.

In the following, these issues will be discussed in more detail with the excitation of WGMs in polymer latex beads as an example. Polymer latex beads, such as polystyrene (PS) microspheres, have become commercially available in a variety of sizes, surface functionalizations, and dopants. In particular, fluorescently doped, magnetizable, and even fluorescently doped and magnetizable particles can be obtained. In addition, the particles typically bear a suitable (bio-)functional coating, which allows for subsequent specific functionalization, e.g., decoration of the beads' surface with specific antibodies and other kinds of specifically binding proteins.

Examples of particle architectures of magnetizable polymer particles are sketched in FIG. 2. The material used for magnetization 2 can be either distributed throughout the polymer core 1 of the particle as shown in FIG. 2(I) or encapsulate the core 1 as shown in FIG. 2(II). The optional, typically organic [optionally metallic, e.g. golden (M. Spasova et al., J. Mater. Chem. Vol. 15, pp. 2095-2098, 2005)] outer coating of the particle mediates the (bio-)functionality of the particle and encapsulates the magnetizable material 2. Because the magnetizable material 2 is typically inorganic, while core 1 and outer coating 3 are typically organic materials, these kinds of particles are often referred to as “hybrid particles”. The coating 3 is optional and may be omitted. In such case, the magnetizable material may be coated individually, e.g. crystallite by crystallite, e.g., for the purpose of protection and (bio-)functionalization. For simplification of the discussion in the following, such intricacies, which do not alter the basic principles, will be omitted.

In the case of an additional doping of such particle with a fluorophore, such as an organic dye or semiconductor quantum dots (QDs), the fluorescent material can either be incorporated in the core 1 or in the outer coating 3 of the particle. It can also be attached onto the surface of the coating 3. Further, fluorescent and magnetic properties can be combined, e.g. by application of doped QDs, which are magnetic and fluorescent at the same time (D. Magana et al., J. Am. Chem. Soc. Vol. 128, pp. 2931-2939, 2006; L. Besombes et al., Acta Phys. Polonica A, Vol. 108, pp. 527-540). In such case, besides providing the fluorescent material, the QDs would additionally take the role of the magnetizable material 2 in FIG. 2, i.e. they may be distributed across the core 1 of the particle or form a shell around the core 1. In this latter case, the magnetizable QDs, i.e., the magnetizable material 2 may be also incorporated into the outer coating 3 or attached to it.

In all these cases, however, it wonders how the presence of the magnetizable material affects the occurrence of optical cavity modes, e.g., in terms of their bandwidths and overall appearance. As has been shown in the literature, optical cavity modes, such as WGMs (A. Weller et al., Appl. Phys. B Vol. 90, pp. 561-567, 2008) or FPMs (A. Weller and M. Himmelhaus, Appl. Phys. Lett. Vol. 89, pp. 241105/1-3, 2006), can be very easily excited in fluorescent polymer microbeads by optical excitation of the fluorescent material. However, in the case of a hybrid particle, the magnetizable material with its drastically different optical properties from that of the polymer should cause a major distortion of such mode evolution. S. K. Mandal et al. (Langmuir Vol. 21, pp. 4175-4179, 2005), for example, studied oil droplets filled with QDs and magnetic nanoparticles (α-Fe₂O₃) of varying concentration in water. For a given QD concentration they found that the QD fluorescence sharply dropped as a function of the magnetic nanoparticle concentration (cf. FIG. 2c of said article) and they could further show that this decrease is due mainly to the strong absorption cross-section of the magnetic nanoparticles. A solid particle, such as a polymer bead, enriched with magnetic nanoparticles in its interior, should experience the same attenuation for light propagating in its interior.

For example, in the case of a polystyrene core, the refractive index of the core without magnetizable material would be around 1.59, while optical absorption within the visible regime is basically negligible. Iron oxide derivatives, such as magnetite and hematite, which are most commonly used in the fabrication of commercially available superparamagnetic particles, have typically high refractive indices (e.g., magnetite ˜2.42, hematite ˜2.87-3.22) and, as already mentioned above, show significant optical absorption in the visible regime (J. Wang et al., J. Am. Ceram. Soc. Vol. 88, pp. 3449-3454, 2005; M. Kerker et al., J. Colloid. Interface Sci. Vol. 71, pp. 176-187, 1979; K. J. Kim et al., J. Korean Phys. Soc. Vol. 51, pp. 1138-1142, 2007; S. K. Mandal et al., Langmuir Vol. 21, pp. 4175-4179, 2005). Therefore, the light of optical cavity modes excited in the core of a hybrid particle doped with iron oxide, such as magnetite or hematite, throughout its volume should experience significant scattering at the polymer/FeₓO_{y} interfaces distributed randomly throughout the core in addition to strong absorption in the magnetic material. Because of the random distribution of these interfaces, scattering will in most cases cause the scattered light to deviate from the propagation path of its cavity mode and thus cause a depletion of the mode's population, which is basically effective as a shortening of the storage lifetime, i.e. lowering of the Q-factor, and thus will become observable as a mode broadening. As detailed in Example 1, absorption of light will obviously have the same effect. Optical cavity mode excitation, which typically requires Q-factors of >100 to become observable in the fluorescent background of a fluorescently doped microresonator, may therefore be envisioned as not possible under such extremely unfavorable conditions and in fact has not been achieved until now.

Surprisingly, however, the inventor of the present invention found that when he doped a magnetic particle of the structure (I) of FIG. 2, i.e., a particle with magnetite distributed across his polystyrene core, with a fluorescent organic dye, WGM observation was observable with almost the same quality (in terms of mode bandwidths) as in particles lacking the magnetizable material (for details, cf. Examples 2 and 3). This unexpected observation thus yielded microscopic WGM sensors with position-control function, which can be used with basically any kind of suitable magnetic tweezers and therefore embodies a new kind of microscopic optical sensor with widespread application potential.

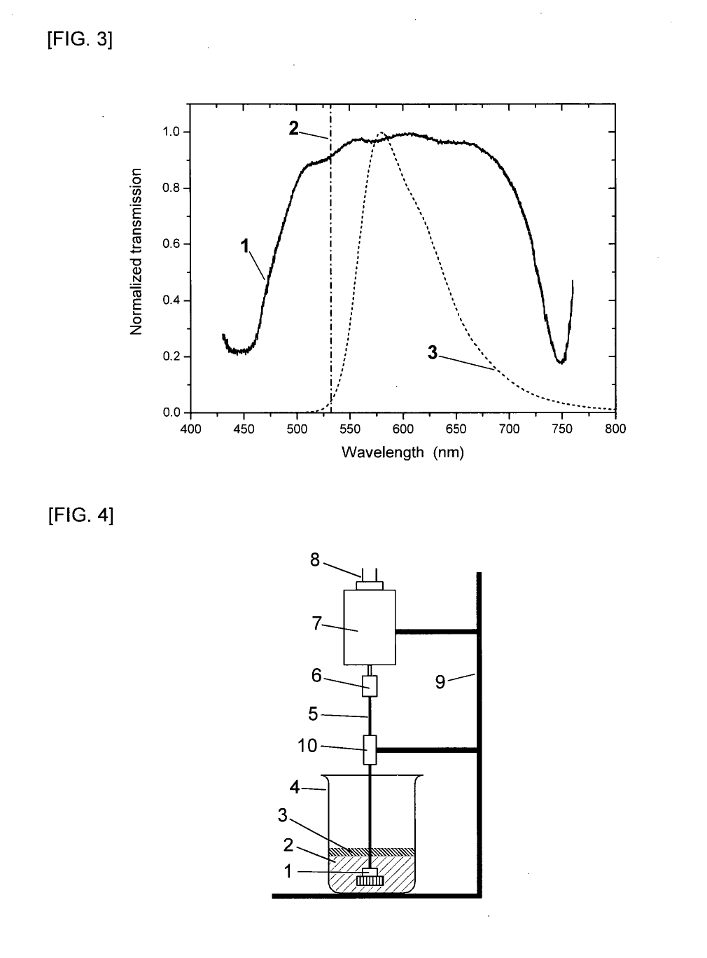

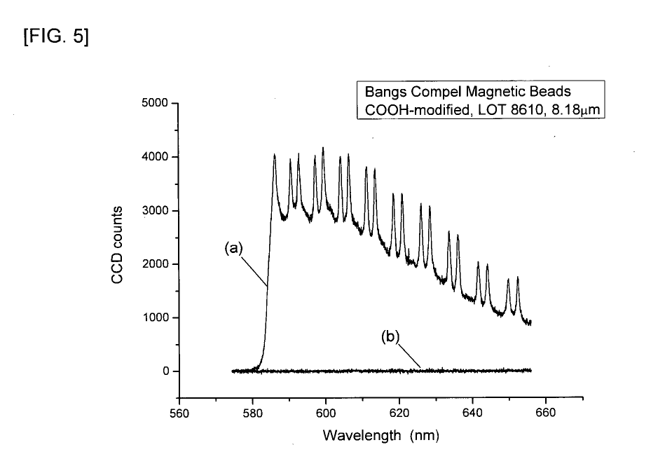

The inventor of the present invention realized that the a priori presumed obstruction of optical cavity mode excitation in magnetic hybrid particles can be overcome in different ways. For example, magnetic materials come in many different colors, depending on chemical composition, crystal structure, and particle size and shape (cf., e.g., Wang et al., J. Am. Chem. Soc. Vol. 88, pp. 3449-3454, 2005). Thus, with properly chosen excitation and fluorescence emission wavelength ranges, a possibly only small window of high transmittance through the magnetizable material may be exploited such that it allows for observable optical cavity mode excitation, i.e. optical cavity modes with bandwidths not too broad for their distinction from the fluorescent background. As an example of utilization of such window, FIG. 3 displays the optical transmittance of a colloidal suspension of magnetite-doped polystyrene beads, i.e. the beads used in the Examples 2 and 3. While the bead suspension shows a distinct brownish color indicating the presence of the magnetite, the transmission spectrum 1 of the colloidal suspension reveals that there is a window of relatively high transmission between 510 and 675 nm. Thus, with Nile Red as fluorescent dye (cf. emission spectrum 3 in FIG. 3) and the second harmonic of a Nd:YAG laser for dye excitation (see excitation wavelength position 2 in FIG. 3), wavelength regimes have been found for fluorescence excitation and emission that fit into this window of high transmission provided by the superparamagnetic beads.

Alternatively, also the structure of the hybrid particles may be exploited to overcome the limitations of optical cavity mode excitations in their interior. As becomes obvious from the example structures shown in FIG. 2, the magnetic material does not occupy the entire particle volume. Therefore, depending on the kind of optical cavity mode excitation, just those parts of the particle may be chosen for their excitation and propagation, which avoid the magnetizable material. It is well known, for example, that WGMs travel very close to the particle/ambient interface with a rapidly decaying field distribution towards the center of the particle (cf., e.g., A. N. Oraevsky, Quant. Electron. Vol. 32, pp. 377-400, 2002). Therefore, under suitable conditions, e.g., by applying a suitable outer coating 3 of sufficient thickness, homogeneity, and transparency, WGMs may be excited and travel just inside this coating. Alternatively, given the scheme II of FIG. 2, FPMs may be excited only in the core 1 of the particle, which is supposedly free of any magnetizable material. The way of excitation of optical cavity modes can then be chosen such that it supports low-loss mode excitation. For example, for optical cavity modes propagating in the coating 3, an evanescent-field coupling scheme may be applied. For FPM excitation in the core 1, the core may be doped with a suitable fluorescent material, which can be excited through the coating of magnetizable material on the core surface (according to scheme II of FIG. 2). In general, the fluorescent material can be distributed inside of the particle in such way that mode excitation with sufficiently low losses for their observation can be achieved. Also, more than one fluorescent material may be applied to support such issue. For example, core 1 and coating 3 may bear different fluorescent materials with different excitation and/or emission wavelength regimes, depending on the optical properties of the hybrid particle. A fluorescent material in the core may be easier to excite from the outside of the particle and then excites the fluorescent material in the coating by means of its fluorescence emission, which in turn excites optical cavity modes, or vice versa, i.e. the fluorescence emission in the coating is easier to excite and then excites in turn that of the core for same purpose.

These deliberations show that a variety of different particle structures and morphologies are possible, which then take advantage of the particular combination of materials chosen. In the following, some examples of suitable combinations will be further explained with the two main schemes of FIG. 2 as the basic guide.
a) A hybrid particle according to schemes 1 or 2 of FIG. 2, wherein the outer coating 3 is chosen such that optical cavity modes can be generated inside of the microresonator by means of near-field coupling of light from the outside.
b) A hybrid particle according to schemes 1 or 2 of FIG. 2, wherein the outer coating 3 bears a fluorescent material, which can be excited by means of suitable excitation light. The coating 3 is chosen such that it facilitates excitation of optical cavity modes, such as WGMs, inside of the microresonator.
c) A hybrid particle according to scheme 2 of FIG. 2, wherein the core 1 contains a fluorescent material, which can be excited by means of suitable excitation light through the magnetizable material 2. For example, the wavelength of the excitation light can be chosen such that the magnetizable material 2 shows low absorption for this wavelength. The core 1 is chosen such that optical cavity modes can be excited inside of the microresonator, e.g. FPMs. The operable wavelength range can be chosen such that the magnetizable material 2 encapsulating the core 1 shows high reflectance, thereby promoting the occurrence of optical cavity modes inside of the core 1
d) A hybrid particle according to scheme 1 of FIG. 2, wherein the core 1 contains a fluorescent material, which can be excited by means of suitable excitation light. The core 1 and the magnetizable material 2 are chosen such that optical cavity modes can be excited inside of the microresonator, e.g. FPMs. To avoid or at least minimize absorption, the excitation and emission wavelength ranges of the fluorescent material can be chosen such that they fall into a window of low absorption of the magnetizable material 2.
e) A hybrid particle according to schemes 1 or 2 of FIG. 2, wherein core 1 and outer coating 3 bear a fluorescent material, which also may be different for core 1 and coating 3. For example, the emission wavelength range of the fluorescent material in the core 1 may at least partially overlap the excitation wavelength range of the fluorescent material of the outer coating 3, and vice versa.
f) A hybrid particle according to schemes 1 or 2 of FIG. 2, wherein the magnetizable material 2 is also a fluorescent material. In this case, the magnetizable material 2 may also be borne by the outer coating 3.
g) A hybrid particle according to schemes 1 or 2 of FIG. 2, wherein the magnetizable material 2 is also a fluorescent material and core and/or outer coating bear an additional fluorescent material. The fluorescent materials of core 1 and outer coating 3 may differ from each other and differ from the magnetizable material 2.
h) A cluster of optical cavities or microresonators wherein at least one constituting optical cavity or microresonator is based on one of the schemes (a)-(g).

### (ii) Materials Section

The microresonators and/or clusters of microresonators of the present embodiment can be manufactured by using materials, which are available to the public. The following explanations of the materials are provided to help those skilled in the art construct the microresonators and clusters of microresonators in line with the description of the present specification.

Cavity Material:

Materials that can be chosen for fabrication of the cavity are those who exhibit low absorption in that part of the electromagnetic spectrum, in which the cavity shall be operated. In the case of fluorescence excitation, this is a region of the emission spectrum of the fluorescent material chosen for excitation of the cavity modes. In the case of evanescent field coupling, it is at least a part of the spectral range of the light source applied. In the case of clusters of microresonators or that more than a single microresonator is used in an experiment, the different cavities involved (either constituting the cluster or those of the different single microresonators) may be made from different materials and also may be doped with different fluorescent materials, e.g. to allow their selective excitation. Also, the cavity (cavities) may consist of heterogeneous materials. For example, the cavity (cavities) may bear a magnetizable material. The magnetizable material (or any other material introduced for other kind of purpose or function of the cavity) may be distributed in a heterogeneous fashion throughout the cavity. For example, it may be distributed such that it does not distort the generation of those optical cavity modes, by which the cavity shall be operated, despite of potentially unfavorable optical properties, such as high refractive index, scattering cross-section, or absorption. In one embodiment, the cavity (cavities) is (are) made from semiconductor quantum well structures, such as InGaP/InGaAlP quantum well structures, which can be simultaneously used as cavity material and as fluorescent material, when pumped with suitable radiation. The typical high refractive index of semiconductor quantum well structures of about 3 and above further facilitates the miniaturization of the cavity or cavities because of the wavelength reduction inside of the semiconductor compared to the corresponding vacuum wavelength. In general, it is advantageous to choose a cavity material of high refractive index to facilitate miniaturization of the cavity or cavities. It is also possible to choose a photonic crystal as cavity material and to coat either the outer surface of the crystal with a fluorescent material, or to embed the fluorescent material into the crystal in a homogeneous or heterogeneous fashion. A photonic crystal can restrict the number of excitable cavity modes, enforce the population in allowed modes, and define the polarization of the allowed modes. The kind of distribution of the fluorescent material throughout the photonic crystal can further help to excite only the wanted modes, while unwanted modes are suppressed due to improper optical pumping.

An example of photonic crystals including two or three-dimensional non-metallic periodic structures that do not allow the propagation of light within a certain frequency range, the so-called “bandgap” of the photonic crystal, was shown by E. Yablonovitch (Scientific American, December issue, pp. 47-55, 2001). The light is hindered from propagation by distributed Bragg diffraction at the periodic non-metallic structure, which causes destructive interference of the differently scattered photons. If the periodicity of such a photonic crystal is distorted by a point defect, e.g. one missing scattering center in the overall periodic structure, spatially confined allowed optical modes within the bandgap may occur, similar to those localized electronic energy levels occurring within the bandgap of doped semiconductors.

In the present invention, the optical cavities shown have a spherical shape. Although such spherical shape is a very useful one, the cavity may in principle have any shape, such as oblate spherical shape, cylindrical, or polygonal shape given that the cavity can support cavity modes, as shown in the related art. The shape may also restrict the excitation of modes into a single or a countable number of planes within the cavity volume.

Fluorescent Material:

As fluorescent material, any type of material can be used that absorbs light at an excitation wavelength λ_{exc}, and re-emits light subsequently at an emission wavelength λₑₘ≠λ_{exc}. Thereby, at least one part of the emission wavelength range(s) should be located within the mode spectrum of the cavity for whose excitation the fluorescent material shall be used. In practice, fluorescent dyes, semiconductor quantum dots, semiconductor quantum well structures, carbon nanotubes (J. Crochet et al., Journal of the American Chemical Society, 129, pp. 8058-9, 2007), Raman emitters, and the like can be utilized. A Raman emitter is a material that uses the absorbed photon energy partially for excitation of internal vibrational modes and re-emits light with a wavelength higher than that of the exciting light. If a vibration is already excited, the emitted light may also have a smaller wavelength than the incoming excitation, thereby quenching the vibration (anti-Stokes emission). In any case, by proper choice of the excitation wavelength many non-metallic materials may show Raman emission, so that also the cavity materials as described above can be used for Raman emission without addition of a particular fluorescent material.

Examples of the fluorescent dyes which can be used in the present invention are shown together with their respective peak emission wavelength (unit: nm): PTP (343), DMQ (360), butyl-PBD (363), RDC 360 (360), RDC 360-NEU (355), RDC 370 (370), RDC 376 (376), RDC 388 (388), RDC 389 (389), RDC 390 (390), QUI (390), BBD (378), PBBO (390), Stilbene 3 (428), Coumarin 2 (451), Coumarin 102 (480), RDC 480 (480/470), Coumarin 307 (500), Coumarin 334 (528), Coumarin 153 (544), RDC 550 (550), Rhodamine 6G (580), Rhodamine B (503/610), Rhodamine 101 (620), DCM (655/640), RDC 650 (665), Pyridin 1 (712/695), Pyridin 2 (740/720), Rhodamine 800 (810/798), and Styryl 9 (850/830). It is necessary to have these dyes that can be excited at 320 nm and emit above 320 nm, e.g. around 450, in order to operate silver-coated microresonators (cf. e.g. WO 2007/129682).

However, for microresonators which are not coated with a silver shell, any other dye operating in the UV-NIR regime could also and/or additionally be used. Examples of such fluorescent dyes are shown: DMQ, QUI, TBS, DMT, p-Terphenyl, TMQ, BPBD-365, PBD, PPO, p-Quaterphenyl, Exalite 377E, Exalite 392E, Exalite 400E, Exalite 348, Exalite 351, Exalite 360, Exalite 376, Exalite 384, Exalite 389, Exalite 392A, Exalite 398, Exalite 404, Exalite 411, Exalite 416, Exalite 417, Exalite 428, BBO, LD 390, α-NPO, PBBO, DPS, POPOP, Bis-MSB, Stilbene 420, LD 423, LD 425, Carbostyryl 165, Coumarin 440, Coumarin 445, Coumarin 450, Coumarin 456, Coumarin 460, Coumarin 461, LD 466, LD 473, Coumarin 478, Coumarin 480, Coumarin 481, Coumarin 485, Coumarin 487, LD 489, Coumarin 490, LD 490, Coumarin 498, Coumarin 500, Coumarin 503, Coumarin 504 (Coumarin 314), Coumarin 504T (Coumarin 314T), Coumarin 510, Coumarin 515, Coumarin 519, Coumarin 521, Coumarin 521T, Coumarin 522B, Coumarin 523, Coumarin 525, Coumarin 535, Coumarin 540, Coumarin 540A, Coumarin 545, Pyrromethene 546, Pyrromethene 556, Pyrromethene 567, Pyrromethene 567A, Pyrromethene 580, Pyrromethene 597, Pyrromethene 597-8C9, Pyrromethene 605, Pyrromethene 650, Fluorescein 548, Disodium Fluorescein, Fluorol 555, Rhodamine 3B Perchlorate, Rhodamine 560 Chloride, Rhodamine 560 Perchlorate, Rhodamine 575, Rhodamine 19 Perchlorate, Rhodamine 590 Chloride, Rhodamine 590 Tetrafluoroborate, Rhodamine 590 Perchlorate, Rhodamine 610 Chloride, Rhodamine 610 Tetrafluoroborate, Rhodamine 610 Perchlorate, Kiton Red 620, Rhodamine 640 Perchlorate, Sulforhodamine 640, DODC Iodide, DCM, DCM Special, LD 688, LDS 698, LDS 720, LDS 722, LDS 730, LDS 750, LDS 751, LDS 759, LDS 765, LDS 798, LDS 821, LDS 867, Styryl 15, LDS 925, LDS 950, Phenoxazone 660, Cresyl Violet 670 Perchlorate, Nile Blue 690 Perchlorate, Nile Red, LD 690 Perchlorate, LD 700 Perchlorate, Oxazine 720 Perchlorate, Oxazine 725 Perchlorate, HIDC Iodide, Oxazine 750 Perchlorate, LD 800, DOTC Iodide, DOTC Perchlorate, HITC Perchlorate, HITC Iodide, DTTC Iodide, IR-144, IR-125, IR-143, IR-140, IR-26, DNTPC Perchlorate, DNDTPC Perchlorate, DNXTPC Perchlorate, DMOTC, PTP, Butyl-PBD, Exalite 398, RDC 387, BiBuQ Stilbene 3, Coumarin 120, Coumarin 47, Coumarin 102, Coumarin 307, Coumarin 152, Coumarin 153, Fluorescein 27, Rhodamine 6G, Rhodamine B, Sulforhodamine B, DCM/Pyridine 1, RDC 650, Pyridine 1, Pyridine 2, Styryl 7, Styryl 8, Styryl 9, Alexa Fluor 350 Dye, Alexa Fluor 405 Dye, Alexa Fluor 430 Dye, Alexa Fluor 488 Dye, Alexa Fluor 500 and Alexa Fluor 514 Dyes, Alexa Fluor 532 Dye, Alexa Fluor 546 Dye, Alexa Fluor 555 Dye, Alexa Fluor 568 Dye, Alexa Fluor 594 Dye, Alexa Fluor 610 Dye, Alexa Fluor 633 Dye, Alexa Fluor 647 Dye, Alexa Fluor 660 Dye, Alexa Fluor 680 Dye, Alexa Fluor 700 Dye, and Alexa Fluor 750 Dye.

Combinations of different dyes may be used, for example with at least partially overlapping emission and excitation regimes, for example to tailor or shift the operation wavelength regime(s) of the microresonator(s).

Water-insoluble dyes, such as most laser dyes, are particularly useful for incorporation into the beads, while water-soluble dyes, such as the dyes obtainable from Invitrogen (Invitrogen Corp., Carlsbad, Calif.), are particularly useful for staining of the environment of the beads, including their surface.

Semiconductor quantum dots that can be used as fluorescent materials for doping the microresonators have been described by Woggon and co-workers (M. V. Artemyev & U. Woggon, Applied Physics Letters 76, pp. 1353-1355, 2000; M. V. Artemyev et al., Nano Letters 1, pp. 309-314, 2001). Thereby, quantum dots (CdSe, CdSe/ZnS, CdS, CdTe for example) can be applied to the present invention in a similar manner as described by Kuwata-Gonokami and co-workers (M. Kuwata-Gonokami et al., Jpn. J. Appl. Phys. Vol. 31, pp. L99-L101, 1992), who have shown that the fluorescence emission of dye molecules can be utilized for population of microresonator cavity modes. The major advantage of quantum dots over dye molecules is their higher stability against degradation, such as bleaching. The same argument holds for semiconductor quantum well structures, e.g. made from InGaP/InGaAlP, which exhibit high stability against bleaching and cannot only be used as fluorescent material but also as cavity material.

The excitation wavelength λ_{exc} of the fluorescent material does not have necessarily to be smaller than its emission wavelength λₑₘ, i.e. λ_{exc}<λₑₘ, since one also can imagine multiphoton processes, where two or more photons of a given energy have to be absorbed by the material before a photon of twice or higher energy will be emitted. Also, as mentioned above, Raman anti-Stokes processes might be used for similar purpose.

Combinations of different fluorescent materials, such as those exemplified above, may be used, for example to tailor or shift the operation wavelength regime(s) of the optical cavity (cavities) or microresonator(s). This may be achieved, for example, by suitable combination of excitation and emission wavelength regimes of the different fluorescent materials applied.

In general, the fluorescent material can be incorporated into the cavity material, adsorbed on the cavities' or microresonators' surface, and/or placed in the cavities' or microresonators' immediate environment, e.g. within the evanescent field of the cavity modes to be excited. The distribution can be used to select the type of cavity modes that are (preferably) excited. For example, if the fluorescent material is concentrated in vicinity of the core surface, whispering gallery modes are more likely to be excited than Fabry Perot modes. If the fluorescent material is concentrated in the centre of the cavity, Fabry Perot modes are easier to excite. Other examples of a heterogeneous distribution are those, in which the fluorescent material is distributed in an ordered fashion, i.e. in terms of regular two- or three-dimensional patterns of volumes with a high concentration of the fluorescent material. In such a case, diffraction effects may occur, which help to excite the cavity in distinct directions, polarizations, and/or modes, e.g., similar to those found in distributed feedback dye lasers.

The fluorescent material may further bear magnetic function, for example as is the case for transition metal-doped QDs or for fluorescently doped magnetizable material. The latter may be achieved, for example, by decorating a magnetizable particle, such as a hematite or magnetite particle, with a fluorescent material, such as a fluorescent dye or QD(s).

Magnetizable Material:

The magnetizable material may be any suitable paramagnetic, superparamagnetic, or ferromagnetic material, such as the transition metals, aluminum, and their composites. Further, any other kind of material doped with a a suitable paramagnetic, superparamagnetic, and/or ferromagnetic material may be applied. For example, quantum dots doped with managanese may be used to provide wanted optical and magnetic properties simultaneously (D. Magana et al., J. Am. Chem. Soc. Vol. 128, pp. 2931-2939, 2006; L. Besombes et al., Acta Phys. Polonica A, Vol. 108, pp. 527-540). The magnetizable material may be introduced in form of particulates or particles, continuous or contiguous films or coatings. The magnetizable material may be further coated or functionalized with other kinds of materials, such as fluorescent material(s) (bio-)functional material(s) to introduce wanted optical or (bio-)functional properties, such as fluorescence, luminescence, specific binding capability, and/or resistance to non-specific binding.

Shell:

The cavities and/or the clusters of cavities or microresonators might be embedded in a shell, which may have a homogeneous thickness or not. The shell may be part of the optional coating 3 of the magnetic particles shown in FIG. 3, part of its core 1, the magnetizable material 2, or may be additionally introduced. It may bear magnetizable material and may consist of any material (metal, dielectric, semiconductor) that shows sufficient transmission at least in a part of the excitation wavelength regime(s) λ_{exc} of the chosen fluorescent material(s). Also, the shell may consist of different materials with wanted properties, for example to render the surface of microresonator(s) and/or cluster(s) of microresonators transparent only at wanted locations and/or areas or—to give another example—to facilitate selective (bio-)functionalization. If the shell bears a magnetizable material, it may located or distributed such that it does not distort other shell functions, such as its optical or (bio-)functional properties or function(s). In the case of semiconductors, the shell becomes transparent when the excitation wavelength is higher than the wavelength corresponding to the bandgap of the considered semiconductor. For a metal, high transparency may be achieved, for example, by taking advantage of the plasma frequency of the metal, above which the conduction electrons of the metal typically do no longer contribute to the absorption of electromagnetic radiation. Among useful metals are aluminum and transition metals, such as silver, gold, copper, titanium, chromium, cobalt and the like. The shell can be continuous, as fabricated for example via evaporation or sputtering, or contiguous as often achieved by means of colloidal metal particle deposition and subsequent electroless plating (Braun & Natan, Langmuir 14, pp. 726-728, 1998; Ji et al., Advanced Materials 13, pp. 1253-1256, 2001; Kaltenpoth et al., Advanced Materials 15, pp. 1113-1118, 2003). Also, the thickness of the shell may vary from a few nanometers to several hundreds of nanometers. The only stringent requirement is that the reflectivity of the shell is sufficiently high in the wanted spectral range to allow for Q-factors with values of Q>1. For FPM in spherical cavities, the Q-factor can be calculated from the reflectance of the shell 4 (or vice versa) by the formula

$$\begin{matrix}[ Math . 5 ] & \\ Q = \frac{{λ}_{m}}{{Δλ}_{m}} = m π \frac{\sqrt{{R}_{sh}}}{1 - {R}_{sh}} & ( 5 )\end{matrix}$$

where Rₛₕ is the reflectance of the shell at λₘ and λₘ is the wavelength of cavity mode m.

Biofunctional Coating:

The microresonator(s) or clusters of microresonators may be coated with a (bio-)functional coating facilitating their (bio-)mechanical and/or (bio-) chemical function. For example, they may be functionalized with specific analytes to initiate a wanted cell response, or to facilitate biomechanical and/or biochemical sensing. The biofunctional coating may be part of the microresonator(s) shell or optional coating 3 of the magnetic particles shown in FIG. 3 or may be additionally introduced. As such, the biofunctional coating may—besides is biofunctional properties or function(s)—also bear optical or magnetic properties, at least temporally. This may also be achieved, for example, by use of optically (e.g. fluorescently or luminescently) and/or magnetizably labeled (bio-) molecules. For sake of brevity, the microresonators or clusters of microresonators will be called “the sensor” in the following.

To render the sensor selective for specific analytes, it is preferred to coat the sensor surface with coupling agents that are capable of (preferably reversibly) binding an analyte, such as proteins, peptides, and nucleic acids. Methods for conjugating coupling agents are well-known to those skilled in the art for various kinds of surfaces, such as polymers, inorganic materials (e.g. silica, glass, titania) and metal surfaces, and are equally suitable for derivatizing the sensor surface of the present invention. For example, in the case of a transition metal-coating (e.g. gold, silver, copper, titanium, chromium, cobalt, and/or an alloy and/or composition thereof), the sensor of the present invention can be chemically modified by using thiol chemistries. For example, the metal-coated non-metallic cores can be suspended in a solution of thiol molecules having an amino group such as aminoethanethiol so as to modify the sensor surface with an amino group. Next, biotin modified with N-hydroxysuccinimide suspended in a buffer solution of pH 7-9 can be activated by EDC, and added to the sensor suspension previously modified by an amino group. As a result, an amide bond is formed so as to modify the metal-coated non-metallic cores with biotin. Next, avidin or streptavidin comprising four binding sites can be bound to the biotin. Next, any biotin-derivatized biological molecule such as protein, peptide, DNA or any other ligand can be bound to the surface of the avidin-modified metal-coated non-metallic cores.

Alternatively, amino-terminated surfaces may be reacted with an aqueous glutardialdehyde solution. After washing the sensor suspension with water, it is exposed to an aqueous solution of proteins or peptides, facilitating covalent coupling of the biomolecules via their amino groups (R. Dahint et al., Anal. Chem., 1994, 66, 2888-2892). If the sensor is first carboxy-terminated, e.g. by exposure to an ethanolic solution of mercaptoundecanoic acid, the terminal functional groups can be activated with an aqueous solution of EDC and N-hydroxysuccinimide. Finally, proteins or peptides are covalently linked to the activated surface via their amino groups from aqueous solution (Herrwerth et al., Langmuir 2003, 19, 1880-1887).

In a similar fashion, also sensors coated with other metals, such as aluminum, and non-metallic sensors can be specifically functionalized. For example, aluminum can be functionalized with molecules containing carboxyl groups, which then may serve as linker groups for further biofunctionalization in a similar fashion as the thiols discussed above. Related kinds of chemistries for surface functionalization are available for a large range of metals, semiconductors, and their oxides. In analogy to the thiol chemistry described above for functionalization of transition metal surfaces, suitable kinds of coupling agents, such as amino-, mercapto-, hydroxy-, or carboxy-terminated siloxanes, phosphates, amines, carboxylic or hydroxamic acids, and the like, can be utilized for chemical functionalization of the sensor surface, on which basis then coupling of biomolecules can be achieved as described or in similar fashion as in the examples above. Suitable surface chemistries can be found in the literature (e.g. A. Ulman, Chem. Rev. Vol. 96, pp. 1533-1554, 1996 and references therein).

Another strategy of functionalizing sensors is related to the use of polymeric coatings. For example, polyelectrolytes (PE), such as PSS, PAA, and PAH, can be used as described in the literature (G. Decher, Science Vol. 277, pp. 1232ff., 1997; M. Losche et al., Macromol. Vol. 31, pp. 8893ff., 1998) to achieve a sensor surface comprising a high density of chemical functionalities, such as amino (PAH) or carboxylic (PAA) groups. Then, for example the same coupling chemistries as described above can be applied to these PE coated sensors. This technique is in general applicable to all kinds of sensors with metallic or non-metallic surface, possibly in combination with a suitable coupling agent as those given above.

A general problem in controlling and identifying biospecific interactions at surfaces and particles is non-specific adsorption. Common techniques to overcome this obstacle are based on exposing the functionalized surfaces to other, strongly adhering biomolecules in order to block non-specific adsorption sites (e.g. to BSA). However, the efficiency of this approach depends on the biological system under study and exchange processes may occur between dissolved and surface bound species. Moreover, the removal of non-specifically adsorbed biomolecules may require copious washing steps, thus, preventing the identification of specific binding events with low affinity.

A solution to this problem is the integration of the coupling agents into inert materials, such as coatings of poly-(PEG) and oligo(ethylene glycol) (OEG). The most common technique to integrate biospecific recognition elements into OEG-terminated coatings is based on co-adsorption from binary solutions, composed of protein resistant EG molecules and a second, functionalized molecular species suitable for coupling agent coupling (or containing the coupling agent itself). Alternatively, also direct coupling of coupling agent to surface-grafted end-functionalized PEG molecules has been reported.

Recently, a COOH-functionalized poly(ethylene glycol) alkanethiol has been synthesized, which forms densely-packed monolayers on gold surfaces. After covalent coupling of biospecific receptors, the coatings effectively suppress non-specific interactions while exhibiting high specific recognition (Herrwerth et al., Langmuir 2003, 19, pp. 1880-1887).

The binding entities immobilized at the surface may be proteins such as antibodies, (oligo-)peptides, oligonucleotides and/or DNA segments (which hybridize to a specific target oligonucleotide or DNA, e.g. a specific sequence range of a gene, which may contain a single nucleotide polymorphism (SNP), or carbohydrates). To reduce non-specific interactions, the binding entities will preferably be integrated in inert matrix materials.

Position Control Functionality:

The sensors of the present invention may be utilized as remote sensors and therefore may require control of their positions and/or movements by external means, for example to control their contact and/or interaction with a selected target, such as a cell. Such control may be achieved by different means. For instance, the sensors may be rendered magnetic and electromagnetic forces may be applied to direct the sensor(s) (C. Liu et al., Appl. Phys. Lett. Vol. 90, pp. 184109/1-3, 2007). For example, paramagnetic and super-paramagnetic polymer latex particles containing magnetic materials, such as iron compounds, are commercially available from different sources (e.g. DynaBeads, Invitrogen Corp., or BioMag/ProMag microspheres, Polysciences, Warrington, Pa.). Because the magnetic material is embedded into a polymeric matrix material, which is typically made of polystyrene, such particles may be utilized in the same or a similar way as optical cavity mode sensors as the non-magnetic PS beads described in the examples below. Alternatively or in addition, a magnetic material/functionality may be borne by the shell of the microresonator(s) and/or their (bio-)functional coating.

Further, the position control may be mediated by means of optical tweezers (J. R. Moffitt et al., Annu. Rev. Biochem. Vol. 77, pp. 205-228, 2008). In such case, the laser wavelength(s) of the optical tweezers may be either chosen such that it does or that it does not coincide with excitation and/or emission wavelength range(s) of the fluorescent material(s) used to operate the sensor. For example, it might be desirable to use the optical tweezers' operating wavelength also for (selective) excitation of (one of) the fluorescent material(s). One advantage of optical tweezers over magnetic tweezers would be that a number of different sensors may be controlled individually at the same time (C. Mio et al., Rev. Sci. Instr. Vol. 71, pp. 2196-2200, 2000).

In other schemes, position and/or motion of the sensors may be controlled by acoustic waves (M. K. Tan et al., Lab Chip Vol. 7, pp. 618-625, 2007), (di)electrophoresis (S. S. Dukhin and B. V. Derjaguin, “Electrokinetic Phenomena”, John Wiley & Sons, New York, 1974; H. Morgan and N. Green, “AC Electrokinetics: colloids and nanoparticles”, Research Studies Press, Baldock, 2003; H. A. Pohl, J. Appl. Phys. Vol. 22, pp. 869-671, 1951), electrowetting (Y. Zhao and S. Cho, Lab Chip Vol. 6, pp. 137-144, 2006), and/or by a microfluidics device that potentially may also be capable of sorting/picking particles and/or cells of desired dimension and/or function (S. Hardt, F. Schönfeld, eds., “Microfluidic Technologies for Miniaturized Analysis Systems”, Springer, New York, 2007).

Also mechanical tweezers may be utilized for position control of the sensor(s), for example by employing a microcapillary capable of fixing and releasing a particle via application of pressure differences (M. Herant et al., J. Cell Sci. Vol. 118, pp. 1789-1797, 2005). The beauty of this approach is that for example in cell sensing experiments, sensors and cells may be manipulated using the same instrumentation (cf. M. Herant et al.). Also combinations of two or more of the schemes described above may be suitable for position control of sensor(s) and/or target(s).

Excitation Light Source:

The choice of light source for optical cavity mode excitation depends on the excitation scheme applied. For excitation via evanescent field coupling via an optical coupler or a focused light beam (see e.g. Oraevsky, Quant. Electron. Vol. 32, pp. 377-400, 2002), the emission wavelength range should match the wanted spectral regime of operation of the cavity. For excitation via fluorescence emission, the light source has to be chosen such that its emission falls into the excitation frequency range ω_{exc} of the fluorescent material. The emission power should be such that it can overcompensate the losses (radiation losses, damping, absorption, scattering) that may occur in the course of excitation of the microcavity or cluster of microcavities. In practice, thermal sources, such as tungsten or mercury lamps may be applied. Lasers or high power light emitting diodes with their narrower emission profiles will be preferably applied to minimize heating of sample and environment. A narrow-band tunable light source may be applied to facilitate the detection of optical cavity modes, e.g., in the case of the evanescent field coupling scheme. If several fluorescent materials are utilized with properly chosen, e.g. non-overlapping, excitation frequency ranges, more than a single light source or a single light source with switchable emission wavelength range may be chosen such that individual microcavities or clusters of microcavities may be addressed selectively, e.g. to further facilitate the readout process or for the purpose of reference measurements. Further, a fluorescent microcavity may be operated above the threshold for stimulated emission of the cavity. In such case, the bandwidths of the operating cavity modes will further narrow, thus improving their quality factors (M. Kuwata-Gonokami et al., Jpn. J. Appl. Phys. (Part 2) Vol. 31, pp. L99ff.). This kind of operation will be particularly useful for the basic schemes of Sections 4.2.1-3.

Irrespective of the excitation scheme, preferred light sources are thermal sources, such as tungsten and mercury lamps, and non-thermal sources, such as gas lasers, solid-state lasers, laser diodes, DFB lasers, and light emitting diodes (LED). For excitation of (a) microresonator(s) or cluster(s) of microresonators, a LED can be preferably chosen such that its emission falls at least partially into the excitation frequency range ω_{exc} of (at least one of) the fluorescent material(s) applied. The emission power should be such that it can overcompensate the losses (radiation losses, damping, absorption, scattering) that may occur in the course of excitation of the microresonators. If several fluorescent materials are utilized with suitably chosen, e.g. non-overlapping or partially overlapping, excitation frequency ranges, more than a single LED may be chosen such that individual microresonators or clusters of microresonators may be addressed selectively, e.g. to further facilitate the readout process or for the purpose of reference measurements. For example, it may be desirable to address only a single microresonator within a cluster. Further, the excitation power of at least one of the LEDs may be chosen such that at least one of the microresonator(s) or cluster(s) of microresonators utilized is/are operated—at least temporally—above the lasing threshold of at least one of the optical cavity modes excited.

Optical Detection of Optical Cavity Modes:

The detection of optical cavity modes of the microcavity (microcavities) or (a) cluster(s) thereof depends on the excitation scheme applied. In the case of an evanescent field coupling scheme, the loss in the excitation light may be monitored as known to those skilled in the art (cf., e.g., F. Vollmer et al., Appl. Phys. Lett. Vol. 80, pp. 4057ff., 2002). Alternatively, light emitted or scattered from the microcavity (microcavities) or (a) cluster(s) thereof may be spectrally analyzed by means of one or more dispersive, e.g., diffractive and/or interferometric, element(s). Optionally, prior its analysis the emitted or scattered light may be collected by means of any kind of light collection optics known to those skilled in the art. For example, the emission can be collected by a microscope objective of suitable numerical aperture and/or any other kind of suitable far-field optics, by an optical fiber, a waveguide structure, an integrated optics device, the aperture of a near field optical microscope (SNOM), or any suitable combination thereof. In particular, the collection optics may utilize far-field and/or near-field aspects for detection of the signal. Then, the collected light can be analyzed by any kind of suitable spectroscopic apparatus based on diffractive and/or interferometric elements. Also the direct interference of the emitted or scattered light may be analyzed, e.g., by means of interference patterns recorded by a CCD camera or other kind of spatially resolving detector. For example, confocal fluorescence microscopes combine fluorescence excitation via laser light with collection of the fluorescence emission with high numerical aperture, followed by filtering and spectral analysis of the fluorescence emission. Since such instruments are often used in biochemical and biological studies, they may provide a convenient tool for implementation of the present invention. Other convenient instruments are, for example, Raman microscopes, which also combine laser excitation and high numerical aperture collection of light signals from microscopic sources with spectral analysis. Further, both kinds of instruments allow simultaneous spectral analysis and imaging, which facilitates tracing of the microresonator position(s) in the course of their operation. If such imaging information is not required, also other kinds of devices, such as fluorescence plate readers, may be applicable.

### (iii) Embodiments

Embodiments of the present invention will be explained hereinafter.

I. Freely Movable Optical Microcavity with Position Control Via Magnetic Forces

An optical microcavity bearing a magnetizable material, wherein the microcavity can (freely) move in a suitable medium, such as a fluid, and its position may be controlled—at least temporally—by magnetization of its magnetizable material through external magnetic forces, e.g., by magnetic tweezers. The optical microcavity can be used for different purposes, e.g. to deliver light generated by means of optical cavity mode excitations in its interior to a wanted location. Also, it can be used to mediate a process of optical sensing at a wanted location or between wanted locations. According to other applications of optical microcavities (cf., e.g., V. S. Ilchenko and A. B. Matsko, IEEE J. Sel. Top. Quantum Electron. Vol. 12, pp. 15ff., 2006; A. N. Oraevsky, Quant. Electron. Vol. 32, pp. 377-400, 2002) it may be used as laser, optical filter, switch, and modulator at the wanted location. This location may be changed in the course of the application of the microcavity as well as the purpose of using the microcavity may be altered. Thus, the microcavity may serve one or more purposes at one location and the same or other purposes at another location.

II. Freely Movable Cluster of Optical Microcavities with Position Control Via Magnetic Forces

A cluster of optical cavities or microresonators, wherein at least one of the optical cavities or microresonators is an optical microcavity bearing a magnetizable material. The cluster can (freely) move in a suitable medium, such as a fluid, and its position may be controlled—at least temporally—by magnetization of its magnetizable material through external magnetic forces, e.g., by magnetic tweezers. The cluster or at least one of its constituting optical cavities or microresonators can be used for different purposes, e.g. to deliver light generated by means of optical cavity mode excitations in its interior to a wanted location. Also, the cluster or at least one of its constituents can be used to mediate a process of optical sensing at a wanted location or between wanted locations. The cluster or at least one of its constituents may be further used as laser(s), optical filters, switches, and modulators at the wanted location. This location may be changed in the course of the application of the cluster as well as the purpose of using the cluster may be altered. Thus, the cluster may serve one or more purposes at one location and the same or other purposes at another location.

### III. Cluster of Optical Microcavities Formed by Freely Movable Optical Microresonators Via Magnetic Forces

A cluster of optical microcavities, which bear a magnetizable material. The magnetizable material of different optical microcavities may be different. The cluster forms from its constituent optical microcavities by application of magnetic forces. For example, the individual microcavities may freely float in a fluid, e.g., in the course of a sensing process, e.g., for collection of a wanted analyte. After switching of magnetic forces (for example: on, off, increase, decrease, alternating field, varying field, alternating field with DC offset) the individual optical microcavities assemble to form the cluster. This process may be reversible and may depend on the applied magnetic field(s).

IV. Optical Microcavity or Cluster of Optical Microcavities in Interaction with Magnetized Material

An optical microcavity or cluster thereof, which interacts with a magnetized material in its environment via magnetic forces. The optical microcavity or cluster thereof may move or rest. For example, it may rest on a surface. The interaction with the magnetized material may help or be part of a sensing process applying optical cavity mode excitations as (one of) the transducer mechanism(s). The interaction with the magnetized material may alter the kinetics and/or sensitivity of the sensing process. For example, it may help the specificity of a specific sensing process, for example by suppression of non-specific binding and/or by supporting specific binding. For example, it may kinetically favour a wanted sensing process. Such and related function may be facilitated, for example, by application of magnetizable particles attached to or incorporated into a wanted material.

Above embodiments are only basic examples and may be easily modified and combined by those skilled in the art.

### (iv) Working Examples

### Example 1

### Q-Factor of an Optical Cavity Mode Transversing a Magnetite Crystallite

This example shows how a single magnetite crystallite with a thickness of only 10 nm can ruin the Q-factor of an optical cavity mode with a trajectory through the crystallite.

For data on the absorption of magnetite crystallites in the visible regime we refer to a recent publication of K. J. Kim et al., J. Korean Phys. Soc. 51 (2007) 1138-1142. FIG. 4 of said article displays the imaginary part of the dielectric function, ∈₂, of thin magnetite films as determined by spectral ellipsometry. From this, it can be seen that for photon energies between 2-3 eV, ∈₂>3. These photon energies correspond to vacuum wavelengths of 620-413 nm and thus to the spectral region of interest.

The real part of the refractive index of magnetite amounts to 2.42 (cf., e.g., http://www.mindat.org).

The relation between imaginary part of the dielectric function, ∈₂, and the complex refractive index,

[Math.6]

ñ=n+iκ (6),

according to textbooks on optics is given by

[Math.7]

∈₂=2nκ (7)

The absorption coefficient of the Lambert-Beer law, Λ, is then given by

$$\begin{matrix}[ Math . 8 ] & \\ Λ = \frac{4 π κ}{{λ}_{0}} = \frac{2 π {ɛ}_{2}}{n {λ}_{0}} , & ( 8 )\end{matrix}$$

where λ₀ is the vacuum wavelength of consideration. For example, for a photon energy of 2 eV, λ₀≈620 nm.

Therefore, assuming ∈₂=3@620 nm as worst case for the spectral regime of interest (413-620 nm; cf. FIG. 4 of K. J. Kim et al.), gives a minimum absorption coefficient of 0.0126/nm. This corresponds to an attenuation of a light beam of wavelength λ₀=620 nm of 11.8% in a magnetite crystallite of only 10 nm thickness.

If we assume that such crystallite is placed into the trajectory of an optical cavity mode with a mode position at 620 nm and if we ignore all other sources of losses (other cavity losses as well as the reflectance at the crystallite surfaces), the mode would be attenuated after one round-trip by 11.8% for WGMs and 23.6% for FPMs, since the latter would pass through the crystallite twice to complete a full roundtrip. According to the definition of the quality factor (eq. 1), this gives at best a quality factor of 1/0.118=8.5 for WGMs and of 1/0.236=4.2 for FPMs. According to eq. 1, the corresponding mode bandwidths would amount to Δλ_{WGM}=73.2 nm and Δλ_{FPM}=146.3 nm, respectively.

The bandwidths of the fluorescence emission of a typical fluorescent material applied for optical cavity mode operation is typically in the range of a few tens (for most QDs) to several tens (for most organic dyes) of nanometers. Thus, caused by the presence of the magnetite crystallite in its trajectory, the bandwidth of the mode would become comparable to or even larger than that of the overall fluorescent background of the fluorescent material and thus would no longer be discernible.

Alternative excitation schemes, such as evanescent-field coupling, are typically applied to optical microcavities with very small FSR, e.g. FSR<1 nm. In such case, obviously, a mode broadening as given above would cause the different optical cavity modes to overlap, thus making them indiscernible.

Altogether, the results indicate that optical cavity mode excitation in a microcavity doped with magnetite or a related magnetizable material appears—á priori—as a fruitless endeavor.

### Example 2

### Preparation of Fluorescently Doped Superparamagnetic Microspheres

This example shows how fluorescently doped superparamagnetic beads can be prepared from commercially available superparamagnetic polymer beads.

Routines for preparation of fluorescently doped polymer beads from non-fluorescent polymer beads have been described in the literature (c.f., e.g., A. Francois & M. Himmelhaus, Appl. Phys. Vol. 94, pp. 031101/1-3, 2009, experimental section available online). Thereby, a liquid two-phase system is formed consisting of an aqueous phase containing the microparticles and a non-aqueous phase containing the dye at a concentration close to saturation. When the solvent of the dye solution evaporates, the remaining solution supersaturates, thus driving the dye into the particles during their short random contacts with the solvent/water interface, which are mainly driven by convective flow and Brownian motion.

To keep the particles in the aqueous phase agitated, typically a magnetic stirrer is applied, which is, however, not applicable in the case of paramagnetic beads, because it would cause the aggregation of the beads in vicinity of the stirrer, thereby hindering their contacts with the dye solution/water interface.

To overcome this problem, a non-magnetic stirrer as sketched in FIG. 2 was set up and applied to the inking process of 8 μm Compel paramagnetic polystyrene beads from Bangs, Laboratories, Inc., Fishers, Ind.

A brass gear wheel 1 of about 13 mm outer diameter bearing 24 cogs of about 1.25 mm length is mounted to a shaft 5, which in turn is connected via a coupler 6 to the shaft of a DC micromotor 7 (Model HS-GM21-ALG, S.T.L. Japan) with electric contacts 8. The contacts 8 are connected to a suitable power supply to drive the motor (0.7-7.2 V DC). The motor further contains a gearbox, which reduces the motor speed from 4500-14,250 rpm to 60-190 rpm depending on the voltage setting and is fixed to a mechanical holder 9 in such way, that a beaker 4 can be placed underneath the motor 7 and the gear wheel 1 can be positioned about 10-20 mm above the inner bottom of the beaker 4. To suppress precession of the gear wheel 1 during motor operation due to improper alignment of the shaft 5 and thus an unwanted distortion of the two-phase interface, an additional bearing 10 made of Nylon is placed just above the beaker for and fixed to the mechanical holder for stabilization of the shaft 5.

The beaker is first filled with a highly diluted suspension 2 (150 mL native bead suspension in 10 mL deionized water) of superparamagnetic microspheres (Compel paramagnetic beads, nominal diameter 8 μm, 5 wt % solids contents, catalog code UMC4N, LOT 8610, Bangs Laboratories, Inc., Fishers, Ind.), then a saturated NR/xylene solution 3 is carefully placed on top of the aqueous suspension to form the aforementioned two-phase system. The power supply was set to 5 V DC, resulting in a moderate speed of the gear wheel 1 due to some friction of the shaft 5 in the bearing 10.

The solution is stirred overnight until the xylene has evaporated. Then, the bead suspension was collected from the beaker by means of a strong neodymium magnet to assure that only superparamagnetic beads are further used and further processed as described in the prior art (A. Francois & M. Himmelhaus, Appl. Phys. Vol. 94, pp. 031101/1-3, 2009, experimental section available online).

### Example 3

### Excitation of WGMs in Fluorescently Doped Superparamagnetic Microspheres

In this example, we demonstrate that optical cavity modes with WGMs as the example can be generated in fluorescent superparamagnetic polymer beads despite the presence of the strongly absorbing and scattering magnetic material.

Materials & Methods.

A drop of suspension of NR-doped superparamagnetic microbeads as prepared according to Example 1 with a nominal diameter of 8 μm was placed on a glass microscopy cover slip. The sample was mounted onto the sample stage of a Nikon TS100 inverted microscope, which was used for observation and selection of suitable microbeads as well as their excitation and detection. For excitation, a picosecond Nd:YAG laser (Model Rapid, Lumera Lasers, Germany) operated at 532 nm was applied. The laser power at the microscope objective used for excitation and detection (Nikon, 100×) was 24.7 μW with a focus of about 20 μm. For detection of the fluorescence emission of the microbeads, the light was guided through the camera port of the microscope to the entrance slit of a high-resolution monochromator (Horiba Yobin-Ivon Triax 550, 600 L/mm grating, width of entrance slit 10 μm) equipped with a cooled CCD camera (Andor Technologies, Belfast, model DU-440 BU). Acquisition settings were 1 s exposure time, 20 accumulations. For further details, we refer to the literature (A. Francois, M. Himmelhaus, Appl. Phys. Lett. 94, 031101 (2009)).

Results.

FIG. 3 displays two spectra (a) and (b), which were obtained from two different microbeads, the first spectrum (a) from a NR-doped microbead, thereby allowing the excitation of optical cavity modes, the second spectrum (b) from a microbead of the native, i.e. non-fluorescent superparamagnetic bead suspension. Obviously, the doped bead shows very nice WGM excitation as that known from the prior art for particles in this size regime (cf., e.g., A. Francois and M. Himmelhaus, Sensors Vol. 9, pp. 6836-6852, 2009), while the non-doped particle does not show any fluorescence emission at all. While this could be expected, there was some concern if the supposedly strong absorption of the picosecond laser excitation by the brownish beads might cause some unexpected effects. Obviously, this is not the case, however.

The example clearly shows that it is possible despite the brownish color of superparamagnetic beads to excite WGMs in their interior.

### REFERENCE SIGNS LIST

1 Brass gear wheel
2 Suspension
3 Solution
4 Beaker
5 Shaft
6 Coupler
7 DC micromotor
8 Electric contacts
9 Mechanical holder
10 Bearing

1. An optical cavity mode apparatus comprising:
at least one microcavity having magnetism;
a light source for supplying light irradiation to the microcavity;
an optical apparatus for detection of optical cavity modes of the microcavity; and
a magnetic controller for magnetically controlling position of the microcavity.

2. The optical cavity mode apparatus according to claim 1, wherein;
the microcavity is selected from a group consisting of a micro particle of an optical cavity substantially free from a fluorescent material, a micro particle of an optical cavity doped with at least one fluorescent material and a micro particle of an optical cavity whose surface is covered with at least one fluorescent material.

3. The optical cavity mode apparatus according to claim 1, wherein;
more than one microcavity is provided to constitute at least one cluster;
the light source supplies light irradiation to at least one of the microcavities to stimulate optical excitation of at least one of the microcavities;
the optical apparatus obtains spectra of at least one of the microcavities stimulated by the light source; and
the magnetic controller controls position of at least one of the microcavities at time for at least one of optical excitation, optical detection and treatment of the microcavity.

2. The optical cavity mode apparatus according to claim 3, wherein the cluster includes one kind of microcavity or a plurality of the kinds of microcavities in combination selected from a group consisting of a micro particle of an optical cavity substantially free from a fluorescent material, a micro particle of an optical cavity doped with at least one fluorescent material and a micro particle of an optical cavity whose surface is covered with at least one fluorescent material, in which the microcavity is given magnetism with aid of addition of magnetic material.

5. A method for sensing a target object using optical mode excitations in at least one microcavity, comprising the steps of:
preparing the microcavity having magnetism;
exciting the microcavity by irradiation of a light source to obtain spectra of the microcavity;
detecting at least one optical cavity mode of the microcavity stimulated by the light source,
wherein the position of the microcavity is controlled by a magnetic controller.

6. The method for sensing the target object according to claim 5, wherein;
the microcavity is selected from a group consisting of a micro particle of an optical cavity substantially free from a fluorescent material, a micro particle of an optical cavity doped with at least one fluorescent material and a micro particle of an optical cavity whose surface is covered with at least one fluorescent material.

7. The method for sensing the target object according to claim 5, wherein;
more than one microcavity is provided to constitute at least one cluster;
the light source supplies light irradiation to at least one of the microcavities to stimulate optical excitation of at least one of the microcavities;
the optical apparatus obtains spectra of at least one of the microcavities stimulated by the light source; and
the magnetic controller controls position of at least one of the microcavities at time for at least one of optical excitation, optical detection and treatment of the microcavity.

8. The method for sensing the target object according to claim 7, wherein the cluster includes one kind of microcavity or a plurality of the kinds of microcavities in combination selected from a group consisting of a micro particle of an optical cavity substantially free from a fluorescent material, a micro particle of an optical cavity doped with at least one fluorescent material and a micro particle of an optical cavity whose surface is covered with at least one fluorescent material, in which the microcavity is given magnetism with aid of addition of magnetic material.

9. A method for sensing a target object using optical mode excitations in at least one microcavity, comprising the steps of:
preparing the microcavity having magnetism;
exciting the microcavity by irradiation of a light source to obtain spectra of the microcavity;
detecting at least one optical cavity modes of the microcavity stimulated by the light source,
wherein the microcavity interacts with magnetized material.

10. The method for sensing the target object according to claim 9, wherein;
the microcavity is selected from a group consisting of a micro particle of an optical cavity substantially free from a fluorescent material, a micro particle of an optical cavity doped with at least one fluorescent material and a micro particle of an optical cavity whose surface is covered with at least one fluorescent material.

11. The method for sensing the target object according to claim 9, wherein;
more than one microcavity is provided to constitute at least one cluster;
the light source supplies light irradiation to at least one of the microcavities to stimulate optical excitation of at least one of the microcavities;
the optical apparatus obtains spectra of at least one of the microcavities stimulated by the light source; and
the magnetic controller controls position of at least one of the microcavities at time for at least one of optical excitation, optical detection and treatment of the microcavity.

12. The method for sensing the target object according to claim 11, wherein the cluster includes one kind of microcavity or a plurality of the kinds of microcavities in combination selected from a group consisting of a micro particle of an optical cavity substantially free from a fluorescent material, a micro particle of an optical cavity doped with at least one fluorescent material and a micro particle of an optical cavity whose surface is covered with at least one fluorescent material, in which the microcavity is given magnetism with aid of addition of magnetic material.

13. The method for sensing the target object according to claim 9, wherein the magnetized material is material to which at least one magnetizable particle is attached to or at least one magnetizable particle is incorporated into.
